(19) United States
(12) Patent Application Publication
(10) Pub. No.: US 2011/0246127 A1
(43) Pub. Date: Oct. 6, 2011

(54) Method for Determining at Least One Controller Parameter of a Dancer Position Control Element

(75) Inventors: Holger Schnabel, Veitshoechheim (DE); Stephan Schultze, Lohr-Wombach (DE); Mario Goeb, Wuerzburg (DE)

(73) Assignee: Robert Bosch GmbH, Stuttgart (DE)

(21) Appl. No.: 13/075,074

(22) Filed: Mar. 29, 2011

(30) Foreign Application Priority Data
Apr. 3, 2010 (DE) 10 2010 013 782.0

(51) Int. Cl. G06F 15/00

(52) U.S. Cl. 702/145

(57) ABSTRACT

A method is disclosed for automatically determining at least one controller parameter of a dancer position control element in a processing machine comprising a dancer, the dancer position of which is registered, wherein, on the basis of the registered dancer position, the rotational speed of a roll is predefined, wherein the at least one controller parameter is determined automatically as a function of a diameter of the roll.

This application claims priority under 35 U.S.C. §119 to German patent application no. 10 2010 013 782.0, filed Apr. 3, 2010 in Germany, the disclosure of which is incorporated herein by reference in its entirety.

The present disclosure relates to a method for determining at least one controller parameter of a dancer position control element and also a computing unit equipped to implement the method.

Although the disclosure will be described below substantially with reference to printing presses, it is not restricted to such an application but instead can be used in all types of processing machines in which the product web or material web runs through what is known as a dancer, the position of which is controlled. The product web can be formed from paper, material, paperboard, plastic, metal, rubber, in the form of film, and so on.

### BACKGROUND

The present disclosure relates to the area of web tension control in processing machines. In processing machines, in particular printing presses, a product web is moved along driven axes (web transport axes), such as pull rolls or feed rolls, and non-driven axes, such as deflection, guide, drying or cooling rolls. The product web is processed simultaneously by means of normally likewise driven processing axes, for example printed, punched, cut, folded, and so on.

In processing machines such as printing presses, in addition to a longitudinal and/or lateral register, for example, the web tension is often also controlled or set in order to achieve an optimum processing result. One known possible way of setting the web tension, in particular for a winder (rewinder or unwind device) makes use of a dancer, in which a moving dancer roller impresses the web tension. The position of the dancer roller, what is known as the dancer position, is kept at a set point by the dancer position control. As long as the dancer is located within its movable mechanical limits, the web tension is substantially maintained by the imposition of force, for example by pneumatics. Dynamic processes will not be explained further here. The dancer has the advantageous property of being able to absorb non-circularities in the web run within relatively large limits without any substantial change in the web tension occurring.

Known controllers, such as P controllers, D controllers, I controllers and so on, and any desired combinations thereof, contain controller parameters which have to be set. Conventional controller parameters are the proportional gain K_{P}, the integral gain K_{I}, the differential gain K_{D}, the integral-action time T_{N}, the derivative-action time T_{V}, delays T and so on.

Heretofore, no methods are known for simplifying or even automating the configuration of the dancer position control. Certainly, a number of methods have been developed by the applicant for simplifying the configuration of web tension controllers:

For instance, EP 1 790 601 A2 illustrates how controller parameters can be determined as a function of product web parameters (e.g. modulus of elasticity), machine parameters (e.g. product web length, product web speed or moment of inertia) and operating parameters (e.g. control deviation).

DE 10 2008 035 639 illustrates the fact that, besides these variables, dead times are also present in the controlled system and can be used to determine the controller parameters.

In DE 10 2009 019 624, not previously published, a description is given of controller configuration as a function of at least one parameter characterizing the product web, such as the modulus of elasticity and/or the cross section, at least one parameter characterizing the processing machine, such as the web speed and/or the section length, and at least one, in particular constant (i.e. not dependent on web speed) and/or speed-dependent, dead time, such as a transit time and/or a measuring time.

However, the method described in the documents cited cannot be transferred to a dancer position control system, since in the case of dancer position control the length of the product web also changes and there is thus a completely different response of the controlled system—specifically an integral response. The configuration of a dancer position control system is therefore carried out substantially by hand. In this case, a step response of the controlled system is normally evaluated in order to determine the system parameters. Via the system parameters, by means of control engineering knowledge, suitable controller parameters can then be determined by the operator.

It is therefore desirable to specify a method for configuring a dancer position control system that is simplified and can preferably be automated.

### SUMMARY

According to the disclosure, a method for determining at least one controller parameter of a dancer position control element for a processing machine and also a computing unit for implementing the method having the features set forth herein is proposed.

The disclosure is based substantially on the finding that a dancer position control element can be configured automatically if, in order to determine at least one controller parameter, the diameter of the axis or roll driven by the dancer position controller is taken into account. On the one hand, in the case of a winder having a dancer position controller, this can be the diameter of the winding device that changes during the winding operation, that is to say the rewinder or unwind device, or, on the other hand, in the case of web tension control with a dancer position controller, the constant diameter of a web transport roll. The latter case will be found, for example, in the control of an infeed or outfeed unit. As a result, the configuration can be automated, so that the operator of the machine no longer has to possess any specialist control engineering knowledge. Set-up runs, which were previously necessary to determine the system parameters (e.g. via a step response) can be omitted. Although mention is made substantially of taking the diameter into account, it is obvious that the consideration of equivalent variables or variables that can be derived therefrom, such as radius or circumference, is also included.

In known web tension control systems having direct web tension measurement, for example by force measuring capsules, i.e. web tension controllers without dancers, which control the controlled variable (web tension) directly via the rotational speed of a limiting clamping point as an actuating signal, a PT1 element with dead time or a PT2 element can be used as a basis for the controlled system to a good approximation. If, on the other hand, a dancer position control system is considered, then the response of the controlled system is in principle different therefrom, since here there is now an integrating controlled system and the position of a dancer roller is controlled instead of the web tension.

The dancer position control element expediently comprises a proportional component and preferably, in addition, an integral and/or a differential component. In particular, it accordingly comprises a P, PI, PD or a PID term. A proportional gain K_{P} and optionally an integral-action time T_{N} and/or a differential-action time T_{V} are determined automatically as controller parameters.

In refinement, the at least one controller parameter is determined regularly or when triggered during operation. The frequency of the determination operation can thus be balanced between optimal control with frequent configuration, on the one hand, and little computational effort with less frequent configuration, on the other hand. If the speed of a roll with a variable diameter is used as actuating variable, more frequent determination of the at least one controller parameter is expedient.

Expediently, when determining the at least one controller parameter, a measurement response of a dancer position acquisition device is taken into account. The dancer position acquisition device outputs the actual position value as a voltage or current value. This relationship between actual position value and measured signal can exhibit a linear or non-linear and a static or dynamic response. A static relationship is preferably taken into account via input and output characteristic curve compensation (for example Wiener or Hammerstein model). A dynamic relationship can on the other hand be taken into account via a non-linear or adaptive controller.

It is advantageous for the at least one controller parameter to be determined as a function of a predefinable weighting factor. It is often the case that controller parameters which are calculated by means of a theoretical approach prove to be non-optimal in practice. The reasons for this which can be listed can be additional, non-determinable delay times, nonlinearities, signal noise, wrongly determined system parameters or the control quality or the web tension response during constant running. In particular, the last point is normally disadvantageous. Although the control loop settles quickly, during constant running, because of the discretization or quantization of the measured results and actuating variables, the result is often irregularity on account of a relatively “powerful” proportional component. A method is preferably proposed in which, as a further input variable, a weighting factor is specified, for example as a measure of “controller sharpness”. For instance, one or all the theoretically determined controller parameters can be multiplied by the weighting factor (e.g. between 0 and 1 but also greater than 1). With the aid of this input parameter, the user can adapt the controller parameters as required. By way of example, in the case of a PI control term, this could be achieved by the proportional gain and/or the integral-action time being multiplied by this percentage factor. Alternatively, in addition to the free stipulation of a weighting factor, a selection from predefined values can also be possible (e.g. 20%, 40%, 50%, 60%, 70%, 80%, 85%, 90%, 95%, 100%, 105%, . . . ). The user can find a suitable setting for his machine type and easily adapt this to other physical variables. In addition, various machine types can be set comparably in this way. The result is a substantial simplification for the user, since he only has to enter (known) physical variables and can bring about a change in the controller parameters automatically calculated therefrom with the aid of this single factor “controller sharpness”. Complex settings of the controller parameters are no longer needed, which saves complicated series of tests and measurement runs.

In refinement, a design criterion for determining the at least one controller parameter is predefined. In order to design controller parameters, various design criteria (e.g. symmetric optimum, root locus curve design, optimum magnitude or Ziegler-Nichols) are known in the literature. By stipulating the criterion to be used in particular in the computing unit according to the disclosure to determine the at least one controller parameter, the quality and speed of the determination can be influenced. These design criteria can to some extent also be designed for response to setpoint changes or interference. Thus, the result for the user is the possibility of switching between response to setpoint changes and response to interference, depending on the machine requirement and the machine state (e.g. set-up or production phase).

A computing unit according to the disclosure, for example a controller of a printing press, is equipped, in particular by means of programming, to carry out a method according to the disclosure.

In addition, the implementation of the disclosure in the form of software is advantageous, since this permits particularly low costs, in particular when an executing computing unit is also used for further tasks and is therefore present in any case. Suitable data storage media for providing the computer program are, in particular, floppy disks, hard disks, flash memories, EEPROMs, CD-ROMs, DVDs, etc. A download of a program via computer networks (Internet, intranet and so on) is also possible.

Further advantages and refinements of the disclosure can be gathered from the description and the appended drawing.

It goes without saying that the features mentioned above and those still to be explained below can be used not only in the respectively specified combination but also in other combinations or on their own without departing from the scope of the present disclosure.

### BRIEF DESCRIPTION OF THE DRAWING

The disclosure is illustrated schematically in the drawing by using exemplary embodiments and will be described extensively in the following text with reference to the drawing.

Description of the Figures

FIG. 1 shows an extract from a processing machine having an unwind device, a dancer and an infeed unit, on which the disclosure can be based,

FIG. 2 shows a schematic illustration of a control loop for the processing machine according to FIG. 1,

FIGS. 3 to 6 show configurations of functional modules for determining controller parameters according to different preferred embodiments of the disclosure.

### DETAILED DESCRIPTION

Without restriction, dancer position control for an unwind operation will be described below. However, it goes without saying that the disclosure can likewise be used for the dancer position control for a rewinding operation or the dancer position control of an infeed or outfeed unit. The illustration has been chosen such that, by using the example of an unwind device with dancer in combination with a following driven roll, both mechanisms, i.e. the driving of a winding device with a varying diameter, on the one hand, and a pull roll with a constant diameter, on the other hand, can be explained.

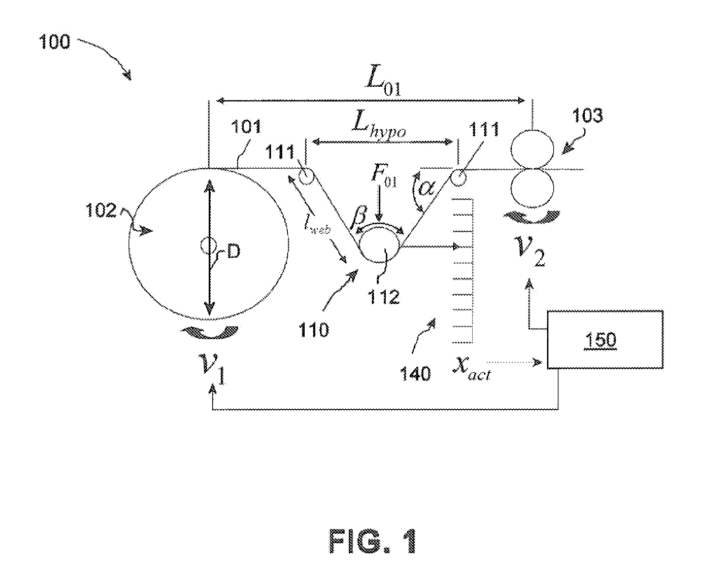

In FIG. 1, an extract from a web-processing machine 100 is illustrated schematically, a product web 101 being unwound from an unwind device 102 as an upstream clamping point and being fed via a dancer 110 to a downstream clamping point, here an infeed unit 103. The dancer 110 comprises two fixed-location deflection rollers 111 and a movable dancer roller 112, which impresses a force F₀₁ and therefore a web tension onto the product web. The distance between the clamping points is designated L₀₁. The dancer position actual value x_{act} is registered by a dancer position acquisition device 140, shown schematically, and transmitted to a computing unit 150, which in particular is set up to control the dancer position. The object of the dancer position control is to keep the position of the dancer roller 112 at an intended position xₛₚ. The computing unit 150, according to one refinement of the disclosure, likewise automatically determines the controller parameters needed for this purpose.

The rotational speeds of the unwind device 102 and of the infeed unit 103 can be driven by the computing unit 150, from which, depending on the respective diameter, the circumferential speeds (web speeds, delivery speeds) v₁ and v₂ result. In the present example, v₁ is used for the dancer position control. During the unwind operation, the diameter D of the unwind device 102 and of the product web roll located on the unwind device changes, i.e. decreases.

The distance between the deflection rollers 111 of the dancer 110 is designated L_{hypo} and, together with the dancer position actual value x_{act}, defines a wrap angle β of the product web 101 around the dancer roller 112. The distance between the fixed-location deflection rollers is frequently chosen such that the wrap is 180°. However, one preferred embodiment of the disclosure is designed such that the controller configuration also copes with any desired wrap angles β and any desired deflection roll spacings L_{hypo}. The length of the product web from the vertex of the deflection roller 111 to the vertex of the dancer roller 112 is designated l_{web}.

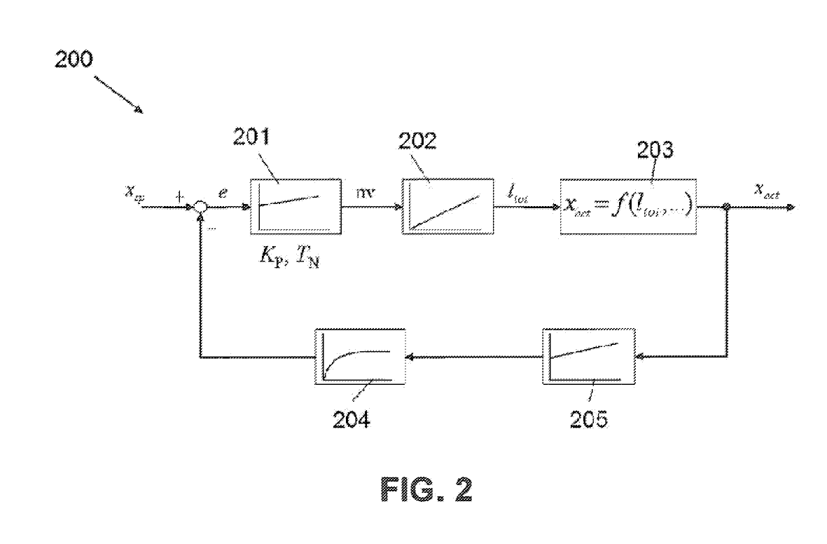

In FIG. 2, the dancer position control on which the disclosure is based is illustrated schematically by using a control loop 200. The desired value xₛₚ is fed to a comparison element or subtraction element, to which the controlled variable, i.e. the dancer position x_{act}, is also fed via elements 205 and 204, which will be discussed in further detail further below. The resultant control deviation e is fed to a dancer position control element 201, which in the present case is formed as a PI element having a proportional gain K_{P} and an integral-action time T_{N}. Without any restriction, the dancer position control element 201 can also be implemented as a P, PD or PID element or as another controller, such as a state controller. For the following description, however, a PI controller having the following transfer function will be assumed:

$${F}_{R} ( s ) = {K}_{P} \cdot ( 1 + \frac{1}{{T}_{N} \cdot s} )$$

In the present case, the control element generates, as actuating signal nv, an additive rotational speed set point, which is led to a controlled system 202 which, in the present case, is designed as an I system. This actuating signal causes a speed adjustment—depending on the control sense—of the unwind device 102 or of the infeed unit 103. In the I section 202 illustrated, a speed change acts as a linear rise or fall in the overall length of the product web 101 between unwind device 102 and infeed unit 103 and therefore in the dancer position actual value x_{act}. The dancer position actual value x_{act}—as illustrated below—is a function of the geometric variables D, L₀₁, L_{hypo}.

The dancer position actual value x_{act} is registered by the dancer position acquisition device 140, in which there is a specific relationship between the registered position actual value and output measured value. This relationship is represented by a linear or non-linear characteristic curve (e.g. a static characteristic curve of a Hammerstein model) 205 in the feedback branch. Since the measured signal is also always subject to a transit dead time and normally to an additional signal filter, there is also a PT1 element 204 in the feedback branch.

The total length lₜₒₜ is given by FIG. 1 by using the following function:

$${l}_{web} = \frac{{L}_{hypo}}{2 \cdot cos ( α )} = \frac{{L}_{hypo}}{2 \cdot cos ( 90 - \frac{β}{2} )}$$

The angle α can be determined via the dancer position actual value x_{act} and the distance between the deflection rolls L_{hypo} as

$$α = arctan ( \frac{2 \cdot {x}_{act}}{{l}_{hypo}} )$$

The total length of the material web is given by

lₜₒₜ=L₀₁−L_{hypo}+2·l_{web}.

By means of transformation, the dancer position actual value is obtained: x_{act}=f(lₜₒₜ,L₀₁,L_{hypo}).

In the extended configuration with a wrap of the material web of β=180°, the total length of the material web is given by:

lₜₒₜ−L₀₁+2·x_{act}+0.5·L_{circum}−D_{dancer},

where L_{circum} designates the circumference of the dancer roller 112 and D_{dancer} designates the diameter of the dancer roller.

By means of transposition, the dancer position actual value is given as a function of the geometry and the current total length. The force impressed into the material web corresponds to half the applied force F₀₁.

The integrating controlled section 202—given a conventional wrap of 180° as a basis—can be described by the following equation.

$${l}_{tot} ( s ) = \frac{1}{2 \cdot s} ( {v}_{1} ( s ) \cdot \frac{1 + {ɛ}_{12} ( s )}{1 + {ɛ}_{01} ( s )} - {v}_{2} ( s ) )$$

where v₁ is the circumferential speed of the upstream clamping point 102,
v₂ is the circumferential speed of the downstream clamping point 103,
ε₀₁ is the stretch of the product web 101 between upstream clamping point 102 and dancer 110, and
ε₁₂ is the stretch of the product web 101 between dancer 110 and downstream clamping point 103.

It can be seen that an increase in the speed v₁(s) of the unwind device 102 effects a rise in the total material web length lₜₒₜ and, conversely, an increase in the speed v₂(s) of the infeed unit 103 effects a reduction in the total material web length. By this means, a positive and negative control sense, as is known in the prior art in web tension control, is described. The positive control sense thus corresponds to control by means of the unwind device as actuating signal, since here a rise in the actuating signal at the same time effects a rise in the output signal. Conversely, a rise in the speed of the infeed unit causes a reduction in the output signal, which corresponds to a negative control sense.

It becomes clear in particular that both circumferential speeds v₁(s) and v₂(s) enter into the controlled system. In real controllers, however, it is not the circumferential speed v(s) but the angular speed u(s) that is known, from which the circumferential speed v(s) is given in a known way:

V(s)=2·π·r(s)·u(s).

Thus, the system response becomes dependent on the radius r(s) of the delimiting clamping points. Since, in the infeed unit 103, a constant radius of the rolls can be assumed, here only the radius (or diameter D) of the unwind device 102 has to be taken into account and, according to the preferred embodiment explained here, is taken into account during the automatic determination of both controller parameters K_{P} and T_{N}. From the system response described above, the controller parameters K_{P} and T_{N} can be determined automatically and by computer implementation by using conventional methods, such as symmetric optimum, root locus curve design, Chien-Rhones-Reswick (CHR) and so on.

For arbitrary wrap angles β (and therefore arbitrary α), the transfer function of the controlled section (without measuring sensor, signal filtering and transit dead times) is given by:

$${l}_{tot} ( s ) = \frac{1}{f ( a ) \cdot s} \cdot ( 2 \cdot π \cdot {r}_{1} ( s ) \cdot {u}_{1} ( s ) \cdot \frac{1 + {ɛ}_{12} ( s )}{1 + {ɛ}_{01} ( s )} 2 \cdot π \cdot {r}_{2} ( s ) \cdot {u}_{2} ( s ) )$$

Here, the function f(α) can have a linear or non-linear response, depending on the geometric conditions. Since this function merely represents a static non-linearity on account of the angular functions, this can be taken into account by an input or output characteristic curve compensation (for example Wiener or Hammerstein model).

The same is true of the measuring sensor, which reproduces the position actual value via a voltage or current value. The ratio of position actual value to measured signal can once more exhibit a linear or non-linear and a static or dynamic response. A static relationship can, for example, be taken into account again via an input or output characteristic curve compensation (Wiener or Hammerstein model). A dynamic relationship can be taken into account, for example, via a non-linear or adaptive controller.

During the determination of the controller parameters, to a first approximation the length L₀₁ between unwind device 102 and infeed unit 103 can be disregarded if the controller is linearized at the working point. A further simplification can be achieved by disregarding the elements 204 and 205 in the feedback branch. As a rule, according to a preferred embodiment, the result is a determination of the controller parameters only while taking account of roll diameter D and control sense, optionally additionally while taking account of delay times and optionally additionally while taking account of the characteristic curve of the dancer position acquisition device.

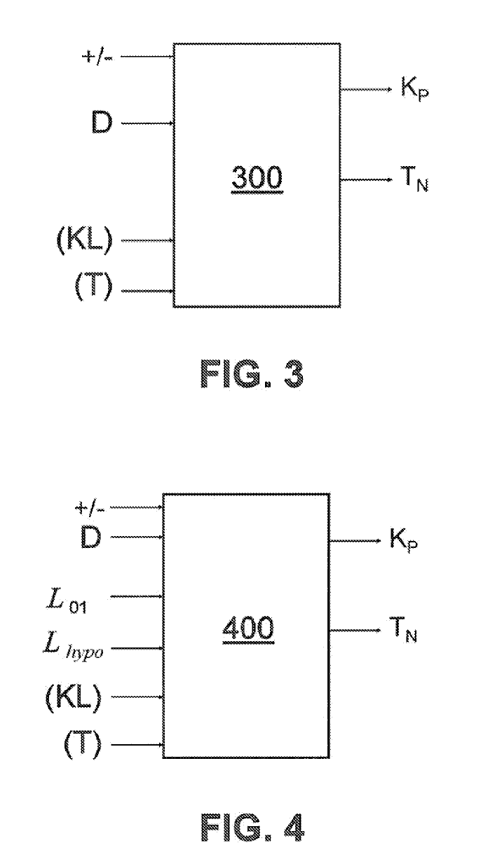

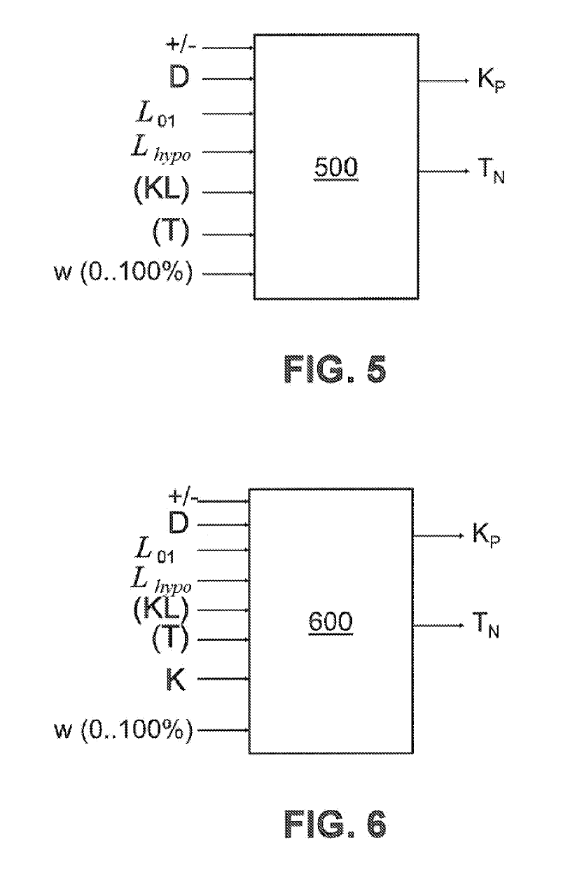

In FIGS. 3 to 6, functional modules 300, 400, 500 and 600 for determining the controller parameters K_{P} and T_{N} are illustrated. In each case, on the left-hand side different input variables are present, which—possibly also optionally—enter into the determination of the controller parameters.

Provision is preferably made to feed the control sense to the functional module. The control sense is designated by +/− in the figures. The control sense substantially influences the sign of the controller output variable and can thus also be fed in at a different point within the control loop. Provision is further made to feed the current diameter D of the winding device (or the constant diameter D of a pull roll) to each of the functional modules illustrated.

Provision is optionally made to feed to the functional modules the characteristic curve KL of the dancer position acquisition device and/or delay times T, taking account of which—as described above—improves the determination of the controller parameters.

The functional module 400 is provided for determining the controller parameters in cases in which the wrap angle β is not 180°. In order to determine the controller parameters here, the distance L_{hypo} between the deflection rollers 111 of the dancer 110 and the length L₀₁ are preferably also taken into account. As an alternative to taking the variables L_{hypo} and L₀₁ into account, the angles α and β can also be taken into account.

According to another preferred refinement, which is represented by the functional module 500, in order to determine the controller parameters a weighting factor w which, for example, can lie between 0 and 100% (values greater than 100% are also conceivable) is also used. As explained further above, the weighting factor w influences what is known as the controller sharpness.

The functional module 600 differs from the functional module 500 in the additional possibility of specifying the design criterion K, for example CHR and so on (see above).

As explained, the controller parameters can be calculated automatically as a function of physical variables. Some of these variables, in particular the diameter of the winding device, change during the processing process. Besides the measurement of these variables, a determination with the aid of a control observer and/or a parameter estimation method is also suggested.

What is claimed is:

1. A method for automatically determining at least one controller parameter of a dancer position control element in a processing machine comprising a dancer, the dancer position of which is registered, wherein, on the basis of the registered dancer position, a rotational speed of a roll is predefined, wherein the at least one controller parameter is determined automatically as a function of a diameter of the roll.

2. The method according to claim 1, wherein the rotational speed of a winding device for rewinding or unwinding the product web is predefined and the at least one controller parameter is determined automatically as a function of the diameter of the winding device that changes during the winding operation.

3. The method according to claim 1, wherein the rotational speed of a transport roll for transporting the product web is predefined and the at least one controller parameter is determined automatically as a function of the substantially constant diameter of the transport roll.

4. The method according to claim 1, wherein the dancer position control element comprises a proportional component, and the at least one controller parameter comprises a proportional gain.

5. The method according to claim 4, wherein the dancer position control element additionally comprises an integral component and/or a differential component, and the at least one controller parameter additionally comprises an integral-action time and/or a differential-action time.

6. The method according to claim 1, wherein the at least one controller parameter is determined regularly or when triggered during operation of the processing machine.

7. The method according to claim 1, wherein, during the determination of the at least one controller parameter, at least one delay time, dead time and/or signal smoothing time is taken into account.

8. The method according to claim 1, wherein, during the determination of the at least one controller parameter, a measurement response of a dancer position acquisition device is taken into account.

9. The method according to claim 1, wherein the dancer comprises two fixed-location deflection rollers and a movable dancer roller and, during the determination of the at least one controller parameter, a distance (between the two fixed-location deflection rollers and/or a wrap angle of the deflection rollers and/or the dancer roller by the product web is taken into account.

10. The method according to claim 1, wherein a predefinable weighting factor enters into the calculation of the at least one controller parameter.

11. The method according to claim 1, wherein a predefinable design criterion enters into the calculation of the at least one controller parameter.

12. The method according to claim 1, wherein the dancer is arranged between an upstream clamping point and a downstream clamping point and the at least one controller parameter is calculated by using the system response
$${l}_{tot} ( s ) = \frac{1}{2 \cdot s} ( {v}_{1} ( s ) \cdot \frac{1 + {ɛ}_{12} ( s )}{1 + {ɛ}_{01} ( s )} - {v}_{2} ( s ) ) ,$$
where v₁ is the circumferential speed of the upstream clamping point, v₂ is the circumferential speed of the downstream clamping point, ε₀₁ is the stretch of the product web between upstream clamping point and dancer, and ε₁₂ is the stretch of the product web between dancer and downstream clamping point.

13. The method according to claim 1, wherein the method is implemented by a computing unit.
